(19) United States
(12) Patent Application Publication
(10) Pub. No.: US 2020/0280400 A1
(43) Pub. Date: Sep. 3, 2020

(54) Transmission of Extra Information

(71) Applicant: Nokia Technologies Oy, Espoo (FI)

(72) Inventors: Zexian LI, Espoo (FI); Klaus HUGL, Wien (AT)

(21) Appl. No.: 16/765,237

(22) PCT Filed: Nov. 24, 2017
(86) PCT No.: PCT/FI2017/050820

§ 371 Date: May 19, 2020

(51) Int. Cl. H04L 1/18; H04L 5/00; H04W 8/24

(52) U.S. Cl. CPC H04L 1/1896; H04L 5/0055; H04W 8/24; H04L 1/1864; H04L 1/1812

(57) ABSTRACT

Apparatuses and methods in a communication system are provided. The solution includes transmitting a set of user terminals parameters related to hybrid automatic repeat request, HARQ, messaging, instructing the user terminals to transmit HARQ feedback using a first set of resources and in case of at least one unsuccessful HARQ messaging reception also using a second set of resources; transmitting data of one or more downlink HARQ processes to a user terminal and receiving HARQ feedback from the first set of resources and the second set of resources.

### FIELD

The exemplary and non-limiting embodiments of the invention relate generally to wireless communication systems. Embodiments of the invention relate especially to apparatuses, methods, and computer program products in communication networks.

### BACKGROUND

Wireless communication systems are under constant development. One of the key areas under development is communication methods which are reliable and have as low latency as possible. Fast reliable communication would enable many services which are difficult to successfully create using present day technology, such as vehicle-to-vehicle communication, tactile internet, motion control, for example. There is a need to define a method how information may be transmitted both reliably and efficiently regarding the use of communication system resources.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to a more detailed description that is presented later.

According to an aspect of the present invention, there are provided methods of claims 1 and 14.

According to an aspect of the present invention, there are provided apparatuses of claims 23 and 24.

### LIST OF DRAWINGS

Embodiments of the present invention are described below, by way of example only, with reference to the accompanying drawings, in which

FIG. 1 illustrates an example of a communication environment where some embodiments of the invention may be applied FIGS. 2, 3A and 3B are flowcharts illustrating embodiments of the invention;

FIG. 4 illustrates an example of usage of shared resource; and

FIGS. 5A, 5B and 6 illustrate simplified examples of apparatuses applying embodiments of the invention.

### DESCRIPTION OF SOME EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may also contain also features, structures, units, modules etc. that have not been specifically mentioned.

Some embodiments of the present invention are applicable to a base station, eNodeB, gNodeB, an access point, an access node, a distributed realisation of a base station, a network element of a communication system, a corresponding component, and/or to any communication system or any combination of different communication systems that support required functionality.

Some embodiments of the present invention are applicable to a user terminal, user equipment, user apparatus, mobile phone, smart phone or any other communication device capable of communicating with the infrastructure of a communication system.

The protocols used, the specifications of communication systems, servers and user equipment, especially in wireless communication, develop rapidly. Such development may require extra changes to an embodiment. Therefore, all words and expressions should be interpreted broadly and they are intended to illustrate, not to restrict, embodiments.

Many different radio protocols to be used in communications systems exist. Some examples of different communication systems are the universal mobile telecommunications system (UMTS) radio access network (UTRAN), HSPA (High Speed Packet Access), long term evolution (LTE®, known also as evolved UMTS Terrestrial Radio Access Network E-UTRAN), long term evolution advanced (LTE-A), fifth generation cellular network, 5G or New radio, NR. For example, 5G/NR, LTE® and LTE-A are developed by the Third Generation Partnership Project 3GPP.

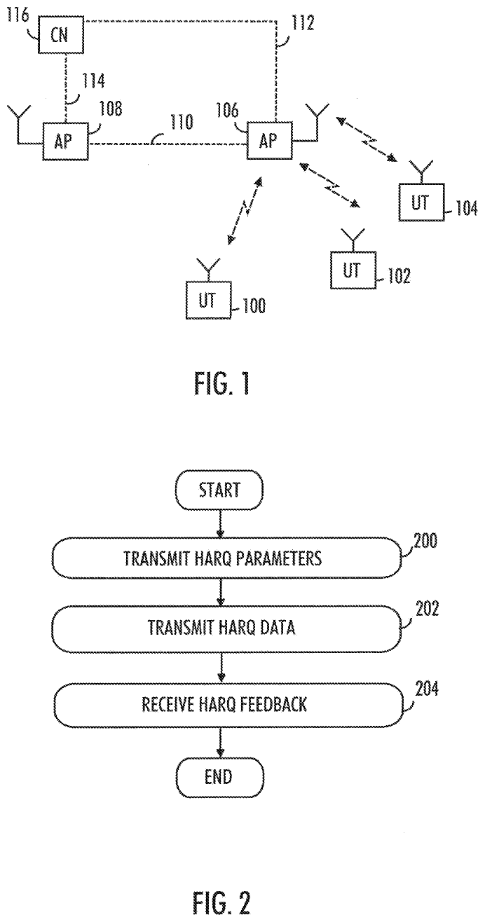

FIG. 1 illustrates a simplified view of a communication environment only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements and the protocols used in or for communication are irrelevant to the actual invention. Therefore, they need not to be discussed in more detail here.

The user terminal UT (or user apparatus, user equipment) 100, 102, 104 illustrates one type of an apparatus to which resources on the air interface are allocated and assigned, and thus any feature described herein with user terminal (user equipment) may be implemented with a corresponding apparatus. The user terminal 100, 102, 104 refers to a portable computing device that includes wireless mobile communication devices operating with or without a subscriber identification module (SIM), including, but not limited to, the following types of devices: mobile phone, smart phone, personal digital assistant (PDA), laptop computer, e-reading device, and tablet.

In the example of FIG. 1, there are a set of base stations, access points, network elements or node apparatuses 106, 108 each having a service area which may be overlapping with service areas of other access points. These access points are base stations which may serving macro cells or so called small cells (SC), micro cells or pico cells, which have considerably smaller coverage area compared to the macro cells. The base stations 106, 108 may be denoted, depending on the communication system, as eNodeBs or gNodeBs, for example. In general, also the term network element may be used.

In the example of FIG. 1, the network elements 106, 108 depict an apparatus of a communication system. The network elements control one or more cells via which the user terminals may access the communication system. For example in an LTE-A based system, such a network element is an evolved node B (eNB, eNodeB). In 5G based systems the term gNodeB is used. The evolved node B, gNodeB, or any corresponding network apparatus controlling one or more cells is a computing device configured to control the radio resources, and connected to the evolved packet core network, thereby providing the user terminal 100 a connection to the communication system. Typically, but not necessarily, the evolved node B or gNodeB may comprise all radio-related functionalities of the communication whereby the evolved node B or gNodeB for example, schedules transmissions by assigning certain uplink resources for the user equipment and informing the user equipment about transmission formats to be used. The network elements 106, 108 may be configured to perform one or more of evolved node B or gNodeB functionalities described below with an embodiment, and to perform functionalities from different embodiments.

The evolved node B or or gNodeB may also provide the cells but the exemplary embodiments may be implemented with a solution having a separate controlling apparatus, and separate cell providing apparatuses controlled by a controlling apparatus. Further, the cells may be macro cells, and/or small cells.

The network element 106, 108 may be connected to each other using a suitable interface 110. For example, the interface may be denoted as X2 interface in LTE or Xn in 5G. Furthermore, each of the network elements or gNodeBs 106, 108 may be connected 112, 114 to Core Network (CN) 116 of the communication system. Let us assume that the user terminal 100 in the example situation of FIG. 1 is connected to a network element 106.

It may be noted that the radio access network of a communication system may be realised using distributed computing where the functionalities of any single entity described in FIG. 1 may be realised using more than one physical apparatus or entity. Also virtual networking may be utilised. In general, virtual networking may involve a process of combining hardware and software network resources and network functionality into a single, software-based administrative entity, a virtual network. Network virtualization may involve platform virtualization, often combined with resource virtualization. Network virtualization may be categorized as external virtual networking which combines many networks, or parts of networks, into the server computer or the host computer.

Wireless communication or mobile communication is utilised more and more in various areas of technology. For example Internet of Things, vehicular communication between devices, autonomous vehicles and other emerging services present challenges for communications networks and systems. As a response, a service category denoted as ultra-reliable low latency communications, URLLC, has been introduced by International Telecommunication Union, ITU. The purpose of URLLC is to provide a service which can support delay-sensitive services requiring reliable connections. In URLLC, the aim is to reduce latency, or time delay between the generation and transmission of data and the reception of transmitted data, to about 1 ms, without sacrificing reliability in data transmission.

In the design of URLLC, the latency and reliability of both data and control channels must be taken into account. One detail that is to be solved is hybrid automatic repeat request, HARQ, messaging and specifically the HARQ reliability of feedback. When HARQ messaging is transmitted from a network element to a user terminal, the user terminal is configured to send feedback to the network element by sending an acknowledgement, ACK, or negative acknowledgement, NACK, depending on whether the HARQ messaging was successfully or unsuccessfully received. The transmission of this feedback should be executed with low latency but with high reliability as well. Failure in feedback reception may lead to problems and delays in communication.

Thus, a novel and enhanced way to allocate resources for HARQ NACK related extra information transmission is proposed. When the user terminal is unable to receive HARQ messaging and a NACK is to be sent, some additional information triggered by the NACK may be sent as well using a separate resource. The additional information may be repetition of the ACK-NACK, NACK, or additional and/or updated Channel State Information, CSI, for example. The proposed solution increases HARQ NACK reliability and, when additional CSI is transmitted, aid the network element in link adaption through the selection of a better Modulation and Coding Scheme, MCS, for the connection between user terminal and the network element.

The flowchart of FIG. 2 illustrates an embodiment in a network element of a communication system. The network element may be a gNodeB, a base station, or a corresponding apparatus. In an embodiment, the proposed solution may be applied in a system employing ultra-reliable low latency communication, URLLC, and this is assumed to be the case in the non-limiting example of FIG. 2.

In step 200, the network element is configured to transmit a set of user terminals parameters related to hybrid automatic repeat request, HARQ, messaging, instructing the user terminals to transmit HARQ feedback using a first set of resources and, in case of at least one unsuccessful HARQ messaging reception, also using a second set of resources. Thus, if the user terminal is unable to decode the HARQ data and is about to transmit NACK using a first set of resources, it is configured to transmit HARQ feedback and/or related information also using the second set of resources. In an embodiment, the parameters related to HARQ messaging comprise information on the first set of resources and/or the second set of resources so that the user terminals may utilise the resources.

In an embodiment, the second set of resources is shared between the user terminals connected to the network element.

In an embodiment, the first set of resources are terminal specific resources. In an embodiment, the first set of resources is shared between a sub set of user terminals connected to the network element.

In an embodiment, the parameters related to HARQ messaging comprise information on what data to send using the shared transmission resource.

In step 202, the network element is configured to transmit data of one or more downlink URLLC HARQ processes to a user terminal.

In step 204, the network element is configured to receive HARQ feedback from first set of resources and a second set of resources. If the HARQ feedback from a user terminal on the first set of resources is NACK, there will be a transmission by the same user terminal also on the second set of resources.

Thus, the network element instructs the user terminal to transmit a normal ACK using first set of resources if it receives HARQ data correctly. However, if the terminal fails to receive HARQ data correctly, it is instructed to transmit NACK using first set of resources and, in addition, to transmit feedback also using second set of resources indicated to the terminal in HARQ parameters. The HARQ parameters may also indicate what the terminals should transmit using the second set of resources.

From the resource allocation point of view, for every user terminal there will be two set of resource allocated for sending feedback information: a first set of resources for HARQ ACK/NACK transmission and a shared second set of time/frequency resources for NACK triggered extra information transmission.

In the first set of resource, the user terminal is configured to send HARQ feedback in a similar as legacy operation in LTE based systems, for example. In the second set of resource, user terminal is configured to send NACK triggered extra information.

Thus, the regular HARQ ACK/NACK feedback and resources for the ACK/NACK as such can be performed and selected as in prior art. To ensure the HARQ NACK reception it is proposed to transmit NACK related extra information using resources which are shared between user terminals.

In an embodiment, the network element is configured to indicate in the parameters related to HARQ messaging user terminals to repeat ACK/NACK information transmitted on the first set of resources also on the second set of resources.

In an embodiment, the network element is configured to indicate in the parameters related to HARQ messaging user terminals to include in the transmission on the second set of resources identification of the HARQ processes of the HARQ messaging transmitted by the network element the transmitted data on the shared second set of resources relates to, i.e. which HARQ processes have a negative acknowledgement.

In an embodiment, the network element is configured to indicate in the parameters related to HARQ messaging user terminals to transmit Channel State Information on the second set of resources.

In an embodiment, the network element is configured to indicate in the parameters related to HARQ messaging user terminals to transmit suggestion of suitable modulation and coding scheme for next transmission of the network element on the second set of resources.

The flowcharts of FIGS. 3A and 3B illustrate embodiments in a user terminal of a communication system. The user terminal is communicating with a network element such as a gNodeB, a base station, or a corresponding apparatus. In an embodiment, the proposed solution may applied in a system employing ultra-reliable low latency communication, URLLC, and this is assumed to be the case in the non-limiting example of FIGS. 3A and 3B.

In step 300, the user terminal is configured to receive from a network element of the communication system parameters related to hybrid automatic repeat request, HARQ, messaging. The parameters may instruct the user terminal to transmit HARQ feedback using a first set of resources and in case of at least one unsuccessful HARQ messaging reception also using a second set of resources.

In step 302, the user terminal is configured to receive from the network element data of one or more downlink URLLC HARQ processes.

In step 304, the user terminal is configured to, based on the received data, transmit HARQ feedback using the first set of resources and also the second set of resources in case of at least one unsuccessful HARQ messaging reception.

FIG. 3B illustrates an example of FIG. 3A in more detail.

After receiving the indication on the HARQ parameters in step 300 and after receiving from the network element data of one or more downlink URLLC HARQ processes in step 302, the user terminal is configured to, in step 310, determine whether the reception was successful.

If the reception was successful, the user terminal is configured to, in step 312, transmit acknowledge, ACK, using first set of resources.

If the reception was unsuccessful, the user terminal is configured to, in step 314, transmit negative acknowledge, NACK, using first set of resources and, in step 316, transmit extra information using the second set of resources. In an embodiment, the steps 314 and 316 may take place at the same time instance.

In an embodiment, the parameters related to HARQ messaging received from the network element comprise information on what unsuccessful HARQ messaging reception triggered information to send using the second set of resources.

In an embodiment, the user terminal is configured to, in step 316, transmit Channel State Information on the second set of resources.

In an embodiment, the user terminal is configured to, in step 316, transmit the ACK/NACK information on the first set of resources also on the second set of resources.

In an embodiment, the user terminal is configured to, in step 316, include in the transmission on the shared second set of resources transmission resources identification of the HARQ processes of the HARQ messaging transmitted by the network element the transmitted data on the second set of resources relates to.

In an embodiment, the user terminal is configured to, in step 316, transmit suggestion of suitable modulation and coding scheme (including for example number of repetitions as well) for next transmission of the network element on the second set of resources.

In an embodiment, the user terminal is configured to, in step 316, transmit updated channel state information, CSI, for next transmission of the network element on the second set of resources.

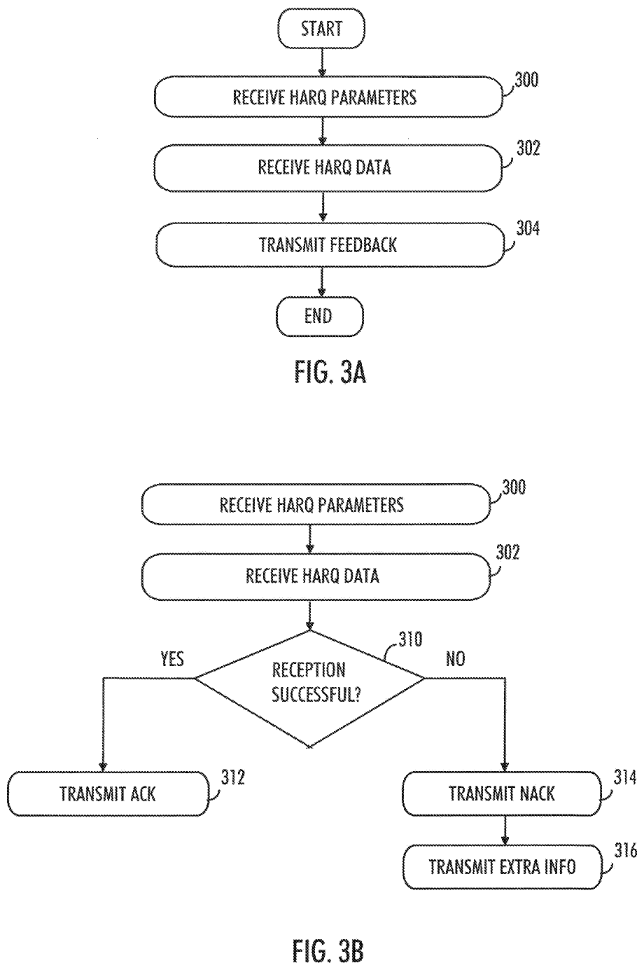

FIG. 4 illustrates an example of reserving the first set of resources and the second set of resources on uplink in terms of time/frequency/code/spatial resource, for example. How the resources are reserved may be system dependent and as such is not relevant regarding the embodiments of the invention.

In this example, the network element 106 has reserved resources 400 and 402 in downlink for transmitting HARQ data to two user terminals 100, 102. The network element 106 has also reserved resources 404 and 406 as first set of resources in uplink for the two user terminals 100, 102. The user terminal may utilise these first set of resources for transmitting ACK or NACK. In addition, the network element 106 has reserved resource 408 as a second set of resources shared between the user terminals 100, 102 for the transmission of extra information in case of negative acknowledgement of the received HARQ data.

Thus, let us here assume as an example, that the network element has transmitted HARQ data to both user terminal 100 and 102 using resources 400, 402 respectively. The user terminal 100 receives the data 400 successfully and transmits an ACK using resource 404. The user terminal 102 receives the data 402 unsuccessfully and transmits a NACK in resource 406 and additionally some extra information using shared second set of resources 408, the extra information being instructed by the network element beforehand.

The network element receives the ACKs and NACKs and the possible extra information transmitted by the user terminals. The network element, such as a gNodeB, for example, may be configured to make a retransmission decision based on the received signals from both the first set of resources and also the extra information on the second set of resources as shown in the following table:

TABLE 1

| Received from terminal | Extra information found | Interpretation |
|---|---|---|
| specific resources | in the shared resource | as NACK |
| ACK | NO | NO |
| ACK | YES | YES |
| NACK | YES | YES |
| NACK | NO | YES |
| uncertainty | YES | YES |
| ACK | uncertainty | NO |
| NACK | uncertainty | YES |

Thus, whenever the network element receives a NACK or extra information, the network will regard this as NACK and retransmission may take place. One of the benefits of this embodiment is increased reliability especially in case with missed NACK as the extra information can be used as indication of NACK as well. The probability of interpreting NACK as ACK and no transmission as ACK can be reduced dramatically.

In an embodiment in LTE based systems, the extra information can be transmitted with physical uplink control channel, PUCCH, resources. The network element may distinguish the transmissions from different user terminals having the shared PUCCH resource using different Demodulation Reference Signals, DM-RS, or user terminal specific scrambling, for example. Also other methods may be used to separate users on a shared channel.

In an embodiment in LTE based systems, the extra information can be transmitted with physical uplink shared channel, PUSCH. In URLLC, the user-plane reliability is quite high. Thus it is reasonable to assume that the extra information is with very high reliability as well. In case user terminals using the shared channel can be identified with different DM-RS or scrambling, for example, the PUSCH resource can be shared among multiple user terminals.

If the extra information is used for sending updated CSI reporting, the information can be applied to all ongoing HARQ process especially considering the case with multiple HARQ process running in parallel.

In case there are multiple parallel HARQ processes, the extra information can be for the first HARQ process having NACK as well for example considering NACK repetition.

As the number of downlink URLLC HARQ processes may be rather large, depending on the design, the content of the extra information can be different as well.

In an embodiment, the additional information transmitted with the shared set of resources can be seen as NACK for all HARQ processes (if there are multiple HARQ processes). It may be that some resources used for retransmission are wasted. However, the reliability can be improved. The presence of extra information may be sufficient to indicate that at least one HARQ process is not successful (i.e. NACK).

In an embodiment, the user terminal may be instructed by the network element to repeat the HARQ-ACK pattern. In this case the additional information can be used to enhance the reliability of HARQ feedback information. For example, assume that a user terminal has four parallel HARQ process. In this case the HARQ feedback on first set of resources may be [1, 1, 0, 0] where “1” corresponds ACK and “0” for NACK. The content in the shared second set of resources may carry the same information and thereby improving the baseline ACK-NACK reliability.

In an embodiment, only NACK information is repeated. In this case, the mapping information between the transmitted NACK on the shared second set of resources and the information of the respective HARQ-IDs and Component Carrier (CC) needs to be sent at the same time as well.

In an embodiment, only HARQ-ID of the processes having NACK information is transmitted on the shared second set of resources.

In an embodiment, if the extra information is for example updated CSI, then such information can be applicable to all ongoing HARQ processes, where each process is then regarded as having NACK or combining such additional information as in above examples by indicating the corresponding HARQ processes in the information. This way, the extra information may be targeted to a specific HARQ process having NACK, where the information on which HARQ processes have NACK and the applicable CSI is specified in the information.

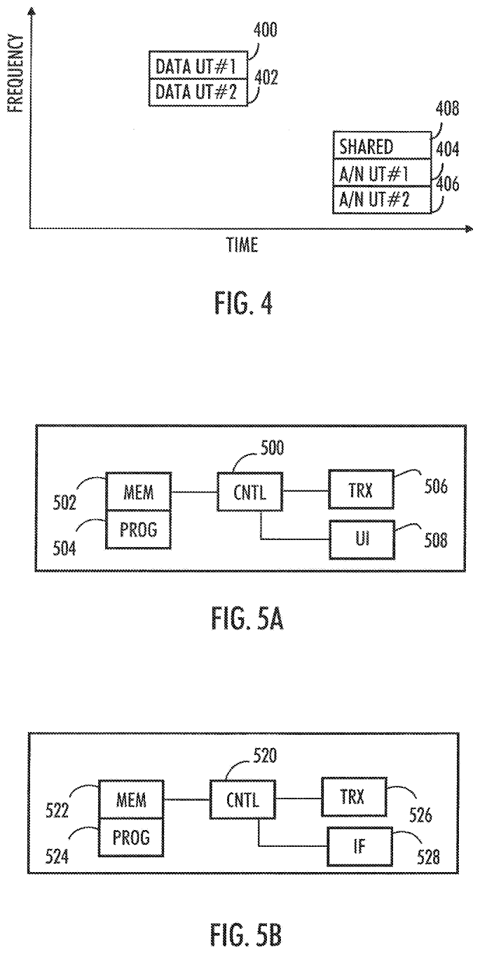

FIG. 5A illustrates an embodiment. The figure illustrates a simplified example of an apparatus applying embodiments of the invention. In some embodiments, the apparatus may be a user terminal 100, 102, 104, user equipment, mobile phone or a part of a user terminal or any corresponding apparatus.

It should be understood that the apparatus is depicted herein as an example illustrating some embodiments. It is apparent to a person skilled in the art that the apparatus may also comprise other functions and/or structures and not all described functions and structures are required. Although the apparatus has been depicted as one entity, different modules and memory may be implemented in one or more physical or logical entities.

The apparatus 100 of the example includes a control circuitry 500 configured to control at least part of the operation of the apparatus.

The apparatus may comprise a memory 502 for storing data. Furthermore the memory may store software 504 executable by the control circuitry 500. The memory may be integrated in the control circuitry.

The apparatus further comprises one or more transceivers 506 configured to connect the apparatus to other devices and network elements of the communication system, such as gNodeBs, eNodeB, base stations or other respective apparatuses.

The interfaces may provide a wired or wireless connection

The apparatus further comprises user interface circuitry 508 comprising a speaker, a microphone, a display which may be touch sensitive, for example.

In an embodiment, the software 504 may comprise a computer program comprising program code means adapted to cause the control circuitry 500 of the apparatus to realise the embodiments described above.

FIG. 5B illustrates an embodiment. The figure illustrates a simplified example of an apparatus or network element applying embodiments of the invention. In some embodiments, the apparatus may be a gNodeB, eNodeB, a network element or a part of a network element.

It should be understood that the apparatus is depicted herein as an example illustrating some embodiments. It is apparent to a person skilled in the art that the apparatus may also comprise other functions and/or structures and not all described functions and structures are required. Although the apparatus has been depicted as one entity, different modules and memory may be implemented in one or more physical or logical entities.

In an embodiment, the apparatus is the gNodeB, eNodeB or access point server 106 of FIG. 1. The apparatus may be realised with distributed computing, i.e. the functions performed by the apparatus may be realised by a multitude of separate apparatuses connected to each other.

The apparatus 106 of the example includes a control circuitry 520 configured to control at least part of the operation of the apparatus.

The apparatus may comprise a memory 522 for storing data. Furthermore the memory may store software 524 executable by the control circuitry 600. The memory may be integrated in the control circuitry.

The apparatus further comprises one or more interface circuitries 526, 528 configured to connect the apparatus to other devices and network elements of the radio access network. The interfaces may provide a wired or wireless connection to user terminals, gNodeBs, eNodeBs and Core Network of a communication system, for example.

In an embodiment, the software 524 may comprise a computer program comprising program code means adapted to cause the control circuitry 520 of the apparatus to realise the embodiments described above.

An embodiment provides a communication system comprising one or more apparatuses of FIGS. 5A and 5B.

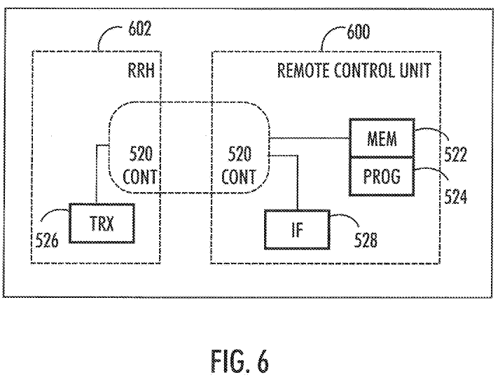

In an embodiment, as shown in FIG. 6, at least some of the functionalities of the apparatus of FIG. 5B may be shared between two physically separate devices, forming one operational entity. Therefore, the apparatus may be seen to depict the operational entity comprising one or more physically separate devices for executing at least some of the described processes. Thus, the apparatus of FIG. 6, utilizing such shared architecture, may comprise a remote control unit RCU 600, such as a host computer or a server computer, operatively coupled (e.g. via a wireless or wired network) to a remote radio head RRH 602 located in the base station. In an embodiment, at least some of the described processes may be performed by the RCU 600. In an embodiment, the execution of at least some of the described processes may be shared among the RRH 602 and the RCU 600.

In an embodiment, the RCU 600 may generate a virtual network through which the RCU 600 communicates with the RRH 602. In general, virtual networking may involve a process of combining hardware and software network resources and network functionality into a single, software-based administrative entity, a virtual network. Network virtualization may involve platform virtualization, often combined with resource virtualization. Network virtualization may be categorized as external virtual networking which combines many networks, or parts of networks, into the server computer or the host computer (e.g. to the RCU). External network virtualization is targeted to optimized network sharing. Another category is internal virtual networking which provides network-like functionality to the software containers on a single system. Virtual networking may also be used for testing the terminal device.

In an embodiment, the virtual network may provide flexible distribution of operations between the RRH and the RCU. In practice, any digital signal processing task may be performed in either the RRH or the RCU and the boundary where the responsibility is shifted between the RRH and the RCU may be selected according to implementation.

The steps and related functions described in the above and attached figures are in no absolute chronological order, and some of the steps may be performed simultaneously or in an order differing from the given one. Other functions can also be executed between the steps or within the steps. Some of the steps can also be left out or replaced with a corresponding step.

The apparatuses or controllers able to perform the above-described steps may be implemented as an electronic digital computer, processing system or a circuitry which may comprise a working memory (random access memory, RAM), a central processing unit (CPU), and a system clock. The CPU may comprise a set of registers, an arithmetic logic unit, and a controller. The processing system, controller or the circuitry is controlled by a sequence of program instructions transferred to the CPU from the RAM. The controller may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

An embodiment provides a computer program embodied on a distribution medium, comprising program instructions which, when loaded into an electronic apparatus, are configured to control the apparatus to execute the embodiments described above.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. Depending on the processing power needed, the computer program may be executed in a single electronic digital computer or it may be distributed amongst a number of computers.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

The embodiments are not, however, restricted to the system given as an example but a person skilled in the art may apply the solution to other communication systems provided with necessary properties. Another example of a suitable communications system is the 5G concept. 5G is likely to use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates. 5G will likely be comprised of more than one radio access technology (RAT), each optimized for certain use cases and/or spectrum. 5G mobile communications will have a wider range of use cases and related applications including video streaming, augmented reality, different ways of data sharing and various forms of machine type applications, including vehicular safety, different sensors and real-time control. 5G is expected to have multiple radio interfaces, namely below 6 GHz, cmWave and mmWave, and also being integradable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

It will be obvious to a person skilled in the art that, as the technology advances, the inventive concept can be implemented in various ways. The invention and its embodiments are not limited to the examples described above but may vary within the scope of the claims.

1. A method in a network element of a communication system, the method comprising:
transmitting a set of user terminals parameters related to hybrid automatic repeat request, HARQ, messaging, instructing the user terminals to transmit HARQ feedback using a first set of resources and in case of at least one unsuccessful HARQ messaging reception also using a second set of resources;
transmitting data of one or more downlink HARQ processes to a user terminal;
receiving HARQ feedback from the first set of resources and the second set of resources.

2. The method of claim 1, wherein the second set of resources is shared between the user terminals connected to the network element.

3. The method of claim 1, wherein the first set of resources are terminal specific resources.

4. The method of claim 1, wherein the first set of resources is shared between a sub set of user terminals connected to the network element.

5. The method of claim 1, wherein the parameters related to HARQ messaging comprise information on the first set of resources and the second set of resources.

6. The method of claim 1, wherein the parameters related to HARQ messaging comprise information on what data to send using the second set of resources.

7. (canceled)

8. The method of claim 1, wherein the parameters related to HARQ messaging instruct user terminals to repeat ACK/NACK information transmitted on the first set of resources also on the second set of resources.

9. (canceled)

10. (canceled)

11. The method of claim 1, further comprising: if HARQ feedback on the second set of resources can be decoded, the data of one or more downlink HARQ processes is retransmitted.

12. The method of claim 1, further comprising: if HARQ feedback on the first set of resources is negative acknowledgement, the data of one or more downlink HARQ processes is retransmitted regardless of the HARQ feedback on the second set of resources.

13. The method of claim 1, wherein if information on the received second set of resources can be decoded, it is interpreted as a negative acknowledgement for all HARQ processes of the HARQ messaging transmitted by the network element.

14. A method in a user terminal of a communication, the method comprising:
receive from a network element of the communication system parameters related to hybrid automatic repeat request, HARQ, messaging, instructing the user terminal to transmit HARQ feedback using a first set of resources and in case of at least one unsuccessful HARQ messaging reception also using a second set of resources;
receive from the network element data of one or more downlink HARQ processes;
based on the received data, transmit HARQ feedback using the first set of resources and also the second set of resources in case of at least one unsuccessful HARQ messaging reception.

15. The method of claim 14, wherein the second set of resources is shared between the user terminals connected to the network element.

16. The method of claim 14, wherein the first set of resources are terminal specific resources.

17. The method of claim 14, wherein the first set of resources is shared between a sub set of user terminals connected to the network element.

18. The method of claim 14, wherein the parameters related to HARQ messaging comprise information on what unsuccessful HARQ messaging reception triggered information to send using the second set of resources.

19. (canceled)

20. The method of claim 14, further comprising: transmit the ACK/NACK information transmitted on the first set of resources also on the second set of resources.

21. (canceled)

22. (canceled)

23. A network element apparatus in communication system, comprising:
at least one processor; and
at least one memory including computer program code,
the at least one memory and the computer program code configured to, with the at least one processor, cause the apparatus at least to perform the method of claim 1.

24. A user terminal apparatus in communication system, comprising:
at least one processor; and
at least one memory including computer program code,
the at least one memory and the computer program code configured to, with the at least one processor, cause the apparatus at least to perform the method of claim 14.

25. (canceled)

26. A computer program product embodied on a distribution medium readable by a computer and comprising program instructions which, when loaded into an apparatus, execute the method according to claim 1.
